(19) United States
(12) Patent Application Publication
(10) Pub. No.: US 2007/0193947 A1
(43) Pub. Date: Aug. 23, 2007

(54) Fluid filter systems and methods

(76) Inventor: Dan David, Watertown, WI (US)

Correspondence Address: RYAN KROMHOLZ & MANION, S.C., POST OFFICE BOX 26618, MILWAUKEE, WI, 53226, US

(21) Appl. No.: 11/707,184

(22) Filed: Feb. 13, 2007

Related U.S. Application Data
(60) Provisional application No. 60/773,520, filed on Feb. 15, 2006.

(51) Int. Cl. B01D 29/00

(52) U.S. Cl. 210/497.01

(57) ABSTRACT

Systems and methods provide a fluid filter having a tubular outer ring and a tubular inner ring slidably seated within the inner diameter of the tubular outer ring. A reusable filter is positioned in-between the tubular outer ring and the tubular inner ring and spans across the lower opening of the tubular inner ring. The tubular inner ring may also include a longitudinal split extending the length of the tubular inner ring, the longitudinal split acting as an expansion spring to allow the tubular inner ring to fit snugly within the tubular outer ring and to hold the filter in place between the tubular outer ring and the tubular inner ring.

### RELATED APPLICATION

This application claims the benefit of U.S. Provisional Patent Application Ser. No. 60/773,520, filed Feb. 15, 2006, and entitled “Fluid Filter System and Methods,” which is incorporated herein by reference.

### FIELD OF THE INVENTION

The present invention relates generally to a reusable filter device, and more particularly to a reusable filter system and methods used in the preparation of a consumable drink, such as coffee or tea.

### BACKGROUND OF THE INVENTION

Most of the coffee making systems on the market today are complex systems of filters, in which the coffee grounds have become part of the filter. The hot water is then run through the complex filter, leaching out any solubles, and/or very fine particulate matter. With these systems, a liquid is added and a liquid is retrieved. The ground coffee is already present in the system before the liquid is added. It is the nature of these complex filters which appears to account for the extremely long time necessary to extract a cup of coffee using these coffee making systems.

One system that may be described as actually filtering a coffee solution (coffee grounds combined with a liquid), is called a French Press, which physically separates the coffee grounds from the liquid by means of a moveable filtering device.

Almost all of these modern day coffee makers, whether percolator, drip, espresso, etc., ultimately work on the principle of moving hot water, or steam, through a concentrated nest of coffee grounds. It hasn't always been that way. “Turkish” style coffee, which is very finely ground coffee, was simply added to a cup of hot water, stirred, and drunk without filtering. Here in the United States, before commercial coffee makers were available, and even today through necessity, coffee can be made by simply bringing a kettle of water to a boil, adding coffee grounds, letting nature take its course, and then—as the old timers will humorously instruct—stirring it with a green stick, or adding a raw egg, to help settle the grounds before drinking.

Typically, most households have an assortment of filters available in the kitchen. Usually they're semi-hemispherical in shape, and range anywhere from the large colander, for straining spaghetti, to the small metal or plastic strainers which are cup size. They perform a multitude of filtering tasks quite well, but one thing they all have in common is that they're all rather difficult to clean. While it is possible to remove most of the spent coffee grounds from a cup size strainer by tapping it on the side of a refuse container, because they tend to be very porous, and have large curved surface areas, they still require large amounts of water to wash, rinse, and clean. This characteristic makes them inefficient for the environmentally sensitive person who would want to save all the spent grounds for composting; and also for those people who have their own septic systems who would prefer not to wash non-digestible materials, and otherwise clean, diluting waters, into their septic system.

Turkish ground coffee is the finest of all grinds, and all other grinds are an increased degree of coarseness. The flavor of these grinds is more or less the same, in that way they all taste like coffee, but, there is a difference in how the taste buds accept them. The course ground coffee seems more acidic, sharp, and clean, whereas the more finely ground coffees, especially the Turkish ground, is more mellow, bitter, and somewhat dusty, producing something similar to the sensation that the particulate matter of chocolate produces on the taste buds. When flavored coffee is added to other ground coffee mixes, the flavored coffee seems to come through more sharply when mixed with course ground coffees than with the finer ground coffees. Today's highly filtered coffees have virtually no particulate matter remaining in the liquid and are rather sharp by comparison.

### SUMMARY OF THE INVENTION

The systems and methods provide a reusable filter system used in the preparation of a consumable drink, such as coffee or tea.

According to one aspect of the invention, the fluid filter system comprises a tubular outer ring including a length, an upper opening, a lower opening, an inner diameter, and an outer diameter, and a tubular inner ring slidably seated within the inner diameter of the tubular outer ring, the tubular inner ring including a length, an upper opening, a lower opening, an inner diameter, and an outer diameter. A filter is positioned in-between the tubular outer ring and the tubular inner ring, the filter spanning across the lower opening of the tubular inner ring.

In one embodiment, the tubular inner ring includes a longitudinal split extending the length of the tubular inner ring, the longitudinal split acting as an expansion spring to allow the tubular inner ring to fit snugly within the tubular outer ring and to hold the filter in place between the tubular outer ring and the tubular inner ring. The tubular outer ring length may be greater than the tubular inner ring length. The tubular outer ring and the tubular inner ring may be made of a variety of materials, including a plastic material.

One aspect of the invention provides a filter system including a reusable filter. The reusable filter may be reusable about 25 times or more, and upwards of hundreds of times. The filter may be sized and configured to filter a ground coffee slurry. The filter may comprise a cross woven material, and the filter may be cross woven and also double strung in at least one direction. The cross woven material may comprise a multifilament polyester or nylon yarn having a size in the range of about 70 denier to about 150 denier. The cross woven material may also comprise a pore size in the range of about 50 by 50 microns to about 300 by 300 microns.

Another aspect of the invention provides a kit of devices to filter a fluid. The kit includes a tubular outer ring including a length, an upper opening, a lower opening, an inner diameter, and an outer diameter, a tubular inner ring including a length, an upper opening, a lower opening, an inner diameter, an outer diameter, and a longitudinal split extending the length of the tubular inner ring, and a filter sized and configured to be positioned in-between the tubular outer ring and tubular inner ring, the filter sized and configured to span across the lower opening of the tubular inner ring. Instructions for assembling the devices are also included. The instructions comprise directions to hold the tubular outer ring in a hand or place the tubular outer ring on a surface, place the filter over the upper opening of the tubular outer ring, squeeze the tubular inner ring to reduce the outer diameter of the tubular inner ring, place the lower opening of the tubular inner ring into the upper opening of the tubular outer ring, and push the tubular inner ring and the filter into the tubular outer ring. It is to be appreciated that reversing these steps will provide the same result.

The instructions may also include directions to push the tubular inner ring into the tubular outer ring until the upper opening of the tubular inner ring is generally flush with the upper opening of the tubular outer ring. The instructions may also include directions to disassemble the assembled devices by pushing the tubular inner ring and the filter out of either the upper opening or the lower opening of the tubular outer ring.

Yet another aspect of the invention provides a method including providing a fluid filter system, the fluid filter system comprises a tubular outer ring including a length, an upper opening, a lower opening, an inner diameter, and an outer diameter, a tubular inner ring slidably seated within the inner diameter of the tubular outer ring, the tubular inner ring including a length, an upper opening, a lower opening, an inner diameter, an outer diameter, and a longitudinal split extending the length of the tubular inner ring, and a filter positioned in-between the tubular outer ring and the tubular inner ring, the filter spanning across the lower opening of the tubular inner ring.

The method further includes providing a slurry comprising an insoluble substance and a liquid, providing a drinking cup, positioning the fluid filter system over the drinking cup, and pouring (i.e., slamming) the slurry into the fluid filter system to filter some, but not all, of the insoluble substance. The slurry may comprise coffee grounds and water. Providing the slurry may comprise boiling a predetermined amount of water and placing a predetermined amount of ground coffee into the boiling water.

The method may also include, after the pouring step, inverting the fluid filter system, and tapping the inverted fluid filter system on a surface to dislodge and remove the filtered insoluble substance.

The fluid filter system and methods utilize a reusable and replaceable filter having a predetermined pore size range that allows fine particles of the ground coffee to pass through the filter, creating a cup of coffee that has a taste and texture different than that of a completely filtered cup of coffee. An outer cylinder and an inner cylinder having a longitudinal slit support the filter and allow for quick and easy cleaning and an occasional filter replacement.

The fluid filter system and methods may be considered a personal coffee filter. It is sized and configured for portability. The fluid filter system and methods provide improved speed of the coffee making process, due to the fact that the coffee solution is pre-made in a pan, and that there is an actual filtering process which separates the spent grounds from the coffee, as opposed to leaching out the coffee through a compound filter composed of both filter(s) and un-wet grounds.

One aspect of the invention provides that any residual coffee solution remaining in the filter may be physically blown through the filter by cupping the hand around the top of the invention, and blowing between the thumb and forefinger, or by simply blowing directly into the invention as though it were the mouth piece of a musical instrument.

An additional aspect provides that once the coffee has been completely extracted from the spent grounds, the filter system can be turned around, and using the same blowing technique used to extract the last drops of coffee, the spent grounds can be removed (i.e., blasted), virtually 100%, as a generally solid plug, leaving only a small rinse to complete the cleaning process. The spent grounds may then be composted. The cleaning process makes the collection process extremely efficient.

An additional aspect provides a small size, overall efficiency, and the ability to use the invention with common cooking utensils, making the invention an ideal personal coffee filter system for use in the home, and in many types of recreational activities, including those that require having to pack and transport the filter in the user's backpack.

### BRIEF DESCRIPTION OF THE DRAWINGS

FIG. 1 is a perspective view of a fluid filter of the present invention.

FIG. 2A is perspective view of a tubular outer ring used with the fluid filter of FIG. 1.

FIG. 2B is a perspective view of a tubular inner ring used with the fluid filter of FIG. 1.

FIG. 2C is a top plan view of a filter used with the fluid filter of FIG. 1.

FIG. 2D is a detailed view of one embodiment of the filter of FIG. 2C.

FIG. 2E is a detailed view of an alternative embodiment of the filter of FIG. 2C.

FIG. 3 is an exploded perspective view of the fluid filter of FIG. 1.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

The various aspects of the invention will be described in connection with a coffee filter system and methods used to produce a coffee drink that includes small particles of ground coffee beans to produce a “Turkish” style cup of coffee. That is because the features and advantages of the invention are well suited for this purpose. Still, it should be appreciated that the various aspects of the invention can be applied in other forms and used in the preparation of other drinks that may also be filtered, such as tea or juices (i.e., orange, apple, and grapefruit). The filter system may also be used for a single cup or more or less than a single cup.

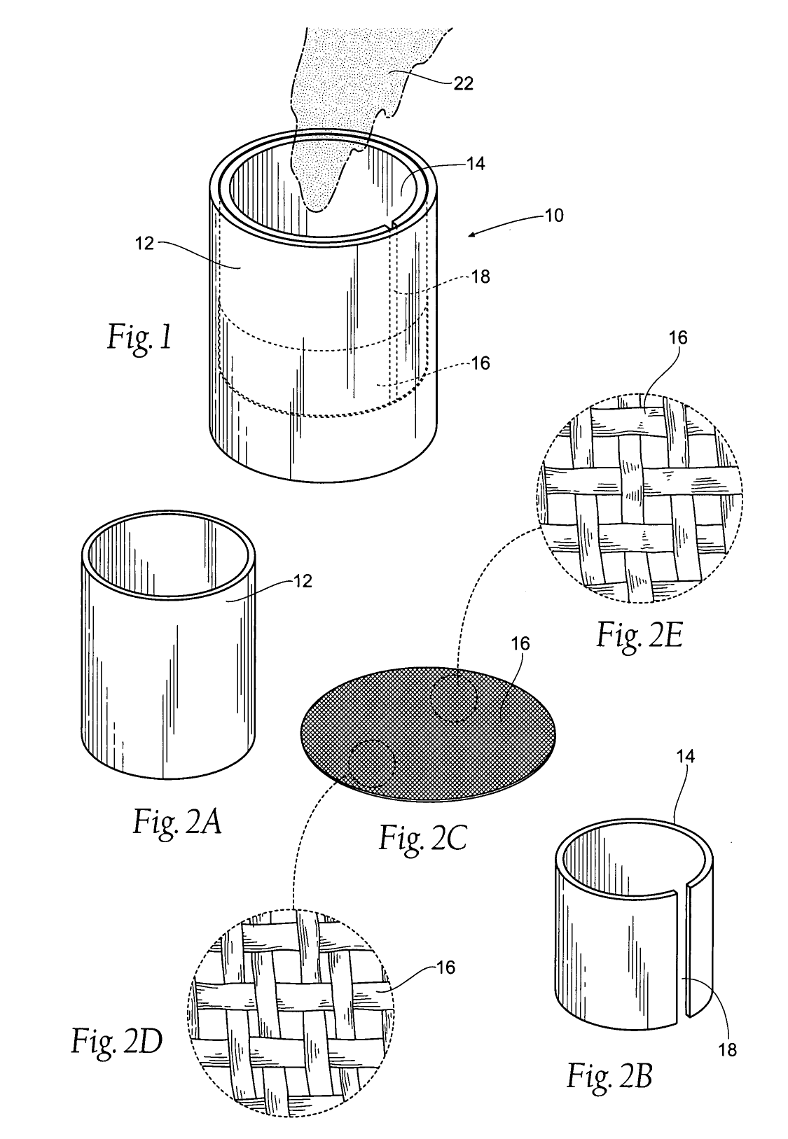

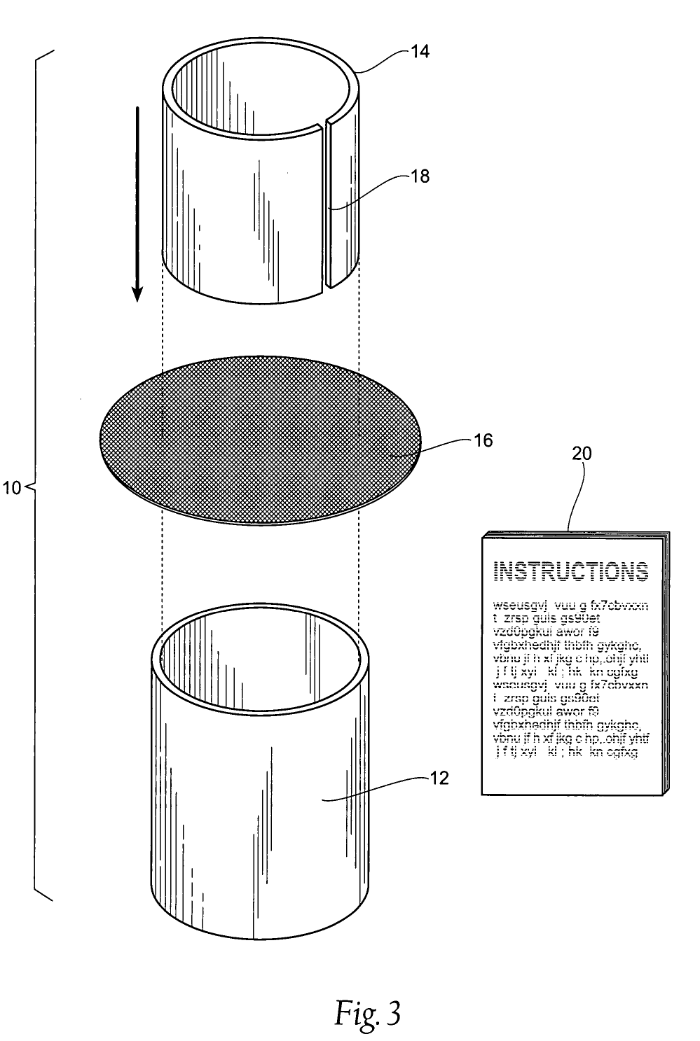

The present invention comprises a reusable coffee filter system 10 used to produce a coffee drink. As can be seen in FIGS. 1 through 3, the filter system 10 comprises a tubular outer cylinder or ring 12, a tubular inner cylinder or ring 14, and a filter 16 sandwiched in-between the outer cylinder 12 and the inner cylinder 14. The inner cylinder 14 has been split longitudinally, the split 18 acting as an expansion spring to allow the inner cylinder 14 to fit snugly within the outer cylinder 12 and to hold the filter 16 in place between the outer and inner cylinder walls. It is to be appreciated that the outer cylinder could include the longitudinal slit in place of, or in addition to, the inner cylinder. The outer cylinder 12 generally has a length that is longer than the inner cylinder 14. Different shapes could also be used, just as long as the inner fits snugly within the outer. In addition, a funnel or cone shape may also be included on the top and/or bottom of the outer cylinder to aid in both the pouring of fluids into the filter system 10, and directing the fluid as it exits the system 10. A handle may also be coupled to the tubular outer cylinder.

The filter 16 may comprise a reusable piece of coarsely woven nylon or similar material, approximately 5/100ths of an inch thick, and may be cross woven, (see FIG. 2E) and may also be double strung (see FIG. 2D). The filter 16 is desirably circular, as shown, although a circular filter is not required. The largest pore size approaches 1/128th of an inch square (approximately 200 microns square), for example. It is to be appreciated that the filter and associated pore size can change depending on the function desired. The pore size is reflective of the filter's particular use.

The filter 16 of the present system may be a reusable filter. As described, the filter construction allows the filter to be used over and over again, and without having to be removed. A single filter may be used 25 times or more, and may last for hundreds of uses. A common paper filter with its extremely small pore size would not provide the same reusability in the fluid filter system 10 of the present invention.

Still referring to FIG. 2D as one representative filter 16, the filter 16 may be woven using a 70 denier multifilament polyester yarn in the warp [lengthwise] direction and a 150 denier multifilament polyester yarn in the filling [crosswise] direction. The plain weave pattern with two warp ends/dent [also called railroad tracking] results in two different hole openings. One opening is generally a square of about 200 to 220 microns and the other is generally a rectangle that measures about 70 by 200 microns. The filter 16 may be finished by scouring and heat set.

FIG. 2E shows an alternative embodiment of a cross woven filter 16 showing a plain weave using 150 denier multifilament polyester yarn in both directions. This embodiment would provide a filter with fewer (smaller) pores per given area because of the thicker 150 denier multifilament polyester yarn running in both directions.

Desirably, a filter 16 used for filtering a ground coffee slurry 22 comprises a pore size having a range of about 50 by 50 microns to about 300 by 300 microns. This range of pore sizes should not be interpreted as limiting, but as describing a range that produces a desired cup of coffee as described herein.

In an exemplary embodiment, the outer cylinder 12 has a length of approximately 2 and ¼ inches and an inner diameter of approximately 1 and ¾ inches. The inner cylinder 14 has a length of approximately 1 and ⅞ inches and an inner diameter of approximately 1 and 9/16 inches. The filter 16 is approximately 3 and ¼ inches in diameter. It is to be appreciated that all of these dimensions can vary and remain within the intent of the invention.

Desirably, the outer tube or cylinder 12 and the inner tube or cylinder 14 are made of a heat resistant plastic material, plastic being a good non-heat conducting material. It is to be appreciated that other materials could be used as well, as could be determined by one of ordinary skill in the art, such as wood, metals, and glass.

To assemble the filter system 10, hold the tubular outer cylinder 12 in a hand, or stand the outer cylinder 12 on a hard surface such as a counter top. Center the filter 16, either side up, on top of the outer cylinder 12. Compress the inner cylinder 14 until the edges of the longitudinal split 18 meet, and then simultaneously slide the inner cylinder 14 and the filter 16 into the outer cylinder 12 until the tops of the two cylinders are generally level. The filter 16 is now held snuggly in place. To disassemble, simply push the inner cylinder 14 and the filter 16 out the bottom of the outer cylinder 12. It is to be appreciated that reversing these steps will provide the same result. For example, the tubular inner cylinder 14 can be held in a hand, and the filter 16 placed on top. While compressing the tubular inner cylinder 14 until the edges of the longitudinal split 18 meet, simultaneously slide the tubular outer cylinder 12 over the filter 16 and the inner cylinder 14. The filter 16 is now held snuggly in place.

To use the filter system 10, first the coffee is prepared. Typical amounts include: Standard mug, 12 ounce filled to the brim with water; One level ⅛ cup scoop of coffee, which includes about ¼ Turkish grind; if desired, One level ¼ teaspoon flavored coffee. Adjust typical amounts for taste and for cup size. Bring the water to a full boil; add the coffee; turn off the heat source (i.e., turn off the burner or remove from heat source); stir to distribute the coffee grounds and reduce the foam. The entire solution, or slurry 22, including the grounds, may be poured into the coffee filter system 10 (see FIG. 1) that is positioned over the mug at anytime after the foam has diminished enough to see the coffee solution. The coffee in the cup is ready to drink. The coffee grounds collected by the filter system may be cleaned out by simply tapping the inverted filter in the refuse or composting container and the coffee grounds will fall out, or by simply physically blowing through the filter system 10, by mouth.

Instructions 20 may be provided with the system 10 that describe the assembly, use, and cleaning, and disassembly of the system 10, as described herein.

One feature of the filter system 10 is its improved speed. The time it takes to brew a cup of coffee from when the coffee solution is poured into the filter system 10 is significantly faster than the time it takes to pour boiling water over grounds that have been placed in a filter.

The selective filter system 10 actually filters, in that a mixture of coffee grounds and water is put into it; extremely fine particulate matter is selectively allowed to pass through the filter 16, and everything else but the liquid is then selectively retained by the filter.

In one embodiment, the filter system 10 measures approximately 2 and ⅝ inches long, by roughly 1 and ⅞ inches wide. The fluid filter system 10 may be considered a small, personal, hand held system used to selectively filter the spent coffee grounds from pan made coffee. The filter system 10 may include a course mesh nylon filter 16 with pores approaching 1/128 of an inch square, the function of which is to allow the passage of the very finest particles of the coffee mixture to pass through the filter, into the cup, and later, onto the taste-buds as a smooth chocolaty sensation; while blocking all of the larger particles which the tongue might distinguish as being unpleasant.

Most coffee making processes are quite lengthy, starting with the coffee grounds already in place before the leaching process is initiated with the gradual addition of hot water; since flavor extraction is very rapid when adding fresh coffee grounds to boiling water, the filter system 10 can turn out a cup of pan made coffee in only a little more time than it takes to bring a cup of water to a boil, add a scoop of fresh coffee grounds, stir, and pour (i.e., slam) through the filter system 10. The reasons for this are several: With pan made coffee, the smallest of the coffee grounds rapidly sink to the bottom of the pan while the larger grounds tend to either float, or remain semi-suspended in the coffee solution. During the pour, the bulk of the larger grounds reaching the filter are pushed to the side by the force of the column of coffee cascading into the filter and offer little resistance, or are large enough that the coffee and the finest grounds simply pass through the interstitial spaces. Because all of the most tiny coffee ground particles settle out rapidly, and reach the filter only in the last few moments of the pour, almost all of the coffee will have passed through the filter before the filter will show any signs of overloading—assuming that the initial mix of coffee grounds is no more than about ¼ Turkish grind.

The filter system 10 has another unique feature; the small diameter, and plastic, non-heat-conducting body, being about the size of the mouth piece of a tuba, make it possible to inject air into the filter system 10 via the mouth. The advantages of this feature are two: by blowing directly into the filter system 10, or by creating a ring around the filter system 10 with the thumb and index filter, one can blow into it and extract the coffee, to the very last drop; and as an aid in cleanup, once the last of the coffee has been blown out of the filter system 10, it's only a matter of turning the filter system 10 around and blowing into it from the other end to eject virtually 100% of the spent grounds, as a solid plug, thus saving the wear and tear on septic systems, and or creating a supply of clean organic materials for composting.

Other than the exemplary embodiment as described being designed for a cup with a volume of about 12 ounces, (the common mug) and calling for a maximum of one full, or slightly heaped ⅛ of a cup scope of fresh coffee grounds, the filter system 10 can, and will work independently of varying amounts of coffee grounds, grind size, grind mixes, and varying amounts of water, and should be considered a broad spectrum coffee filter.

The foregoing is considered as illustrative only of the principles of the invention. Furthermore, since numerous modifications and changes will readily occur to those skilled in the art, it is not desired to limit the invention to the exact construction and operation shown and described. While the preferred embodiments have been described, the details may be changed without departing from the invention, which is defined by the claims.

I claim:

1. A fluid filter system comprising
a tubular outer ring including a length, an upper opening, a lower opening, an inner diameter, and an outer diameter,
a tubular inner ring slidably seated within the inner diameter of the tubular outer ring, the tubular inner ring including a length, an upper opening, a lower opening, an inner diameter, and an outer diameter, and
a filter positioned in-between the tubular outer ring and the tubular inner ring, the filter spanning across the lower opening of the tubular inner ring.

2. A system according to claim 1
wherein the tubular inner ring includes a longitudinal split extending the length of the tubular inner ring, the longitudinal split acting as an expansion spring to allow the tubular inner ring to fit snugly within the tubular outer ring and to hold the filter in place between the tubular outer ring and the tubular inner ring.

3. A system according to claim 1
wherein the tubular outer ring length is greater than the tubular inner ring length.

4. A system according to claim 1
wherein the filter is a reusable filter.

5. A system according to claim 4
wherein the reusable filter is reusable about 25 times or more.

6. A system according to claim 4
wherein the filter is sized and configured to filter a ground coffee slurry.

7. A system according to claim 1
wherein the filter comprises a cross woven material.

8. A system according to claim 7
wherein the filter is cross woven and also double strung in at least one direction.

9. A system according to claim 7
wherein the cross woven material comprises a multifilament polyester or nylon yarn having a size in the range of about 70 denier to about 150 denier.

10. A system according to claim 7
wherein the tubular outer ring and the tubular inner ring are made of a plastic material.

11. A kit of devices to filter a fluid comprising
a tubular outer ring including a length, an upper opening, a lower opening, an inner diameter, and an outer diameter,
a tubular inner ring including a length, an upper opening, a lower opening, an inner diameter, an outer diameter, and a longitudinal split extending the length of the tubular inner ring,
a filter sized and configured to be positioned in-between the tubular outer ring and tubular inner ring, the filter sized and configured to span across the lower opening of the tubular inner ring, and
instructions for assembling the devices, the instructions comprising directions to hold the tubular outer ring in a hand or place the tubular outer ring on a surface, place the filter over the upper opening of the tubular outer ring, squeeze the tubular inner ring to reduce the outer diameter of the tubular inner ring, place the lower opening of the tubular inner ring into the upper opening of the tubular outer ring, and push the tubular inner ring and the filter into the tubular outer ring, and/or instructions describing the reverse procedure to assemble the devices.

12. A kit according to claim 11
wherein the instructions include directions to push the tubular inner ring into the tubular outer ring until the upper opening of the tubular inner ring is generally flush with the upper opening of the tubular outer ring.

13. A kit according to claim 11
wherein the instructions include directions to disassemble the assembled devices by pushing the tubular inner ring and the filter out of either the upper opening or the lower opening of the tubular outer ring.

14. A kit according to claim 11
wherein the tubular outer ring length is greater than the tubular inner ring length.

15. A kit according to claim 11
wherein the filter is a reusable filter.

16. A method comprising
providing a fluid filter system, the fluid filter system comprising
a tubular outer ring including a length, an upper opening, a lower opening, an inner diameter, and an outer diameter,
a tubular inner ring slidably seated within the inner diameter of the tubular outer ring, the tubular inner ring including a length, an upper opening, a lower opening, an inner diameter, an outer diameter, and a longitudinal split extending the length of the tubular inner ring, and
a filter positioned in-between the tubular outer ring and the tubular inner ring, the filter spanning across the lower opening of the tubular inner ring,
providing a slurry comprising an insoluble substance and a liquid,
providing a drinking cup,
positioning the fluid filter system over the drinking cup, and
pouring the slurry into the fluid filter system to filter some, but not all, of the insoluble substance.

17. A method according to claim 16
wherein the slurry comprises coffee grounds and water.

18. A method according to claim 16
wherein providing a slurry comprises boiling a predetermined amount of water and placing a predetermined amount of ground coffee into the boiling water.

19. A method according to claim 16
further including, after the pouring step, inverting the fluid filter system, and
tapping the inverted fluid filter system on a surface to dislodge and remove the filtered insoluble substance.

20. A method according to claim 16
wherein the filter comprises a reusable cross woven material.
